(19) United States
(12) Patent Application Publication
(10) Pub. No.: US 2019/0047317 A1
(43) Pub. Date: Feb. 14, 2019

(54) CYLINDRICAL MOLDED ARTICLE

(71) Applicant: ASAHI KASEI KABUSHIKI KAISHA, Tokyo (JP)

(72) Inventors: Yuki KUROSU, Tokyo (JP); Naoki TAKAGI, Tokyo (JP)

(73) Assignee: ASAHI KASEI KABUSHIKI KAISHA, Tokyo (JP)

(21) Appl. No.: 16/050,552

(22) Filed: Jul. 31, 2018

(30) Foreign Application Priority Data
Aug. 9, 2017 (JP) 2017-154514

(51) Int. Cl. B43K 7/02; B32B 1/08; B43K 5/02; B32B 3/26; B32B 27/30

(52) U.S. Cl. CPC B43K 7/02; B32B 1/08; B43K 5/02; B32B 3/26; B32B 2309/105; B32B 2250/02; B32B 2307/7248; B32B 2307/7244; B32B 2307/7246; B32B 27/304

(57) ABSTRACT

It is an object to provide a cylindrical molded article that can inhibit the transmission of components having SP values in a relatively wide range. A cylindrical molded article having a cylindrical resin layer I comprising a vinylidene chloride copolymer; and a cylindrical resin layer II disposed inside the resin layer I and comprising a resin having an SP value of 12.0 (cal/cm³)^{1/2} or more, and having a total thickness of 100 μm or more.

### BACKGROUND OF THE INVENTION

### Field of the Invention

The present invention relates to a cylindrical molded article.

### Description of the Related Art

Conventionally, containers in various forms are developed, and foods and drinks, seasonings, cosmetics, drugs, and the like are sold filled and packaged in containers. As such containers, particularly various containers to which plugs such as spouts are attached as seen in the packaging of foods and drinks, and various containers to which ports or tubes connected to ports are attached as seen in the packaging of clothing are proposed. Many of all of these plugs, ports, and tubes have tubular structures so as to form flow paths through which the contents of the containers can pass.

For these containers, the contents to be filled are different, but from the viewpoint of the suppression of the degradation of the contents (the maintenance of quality), maintenance in terms of hygiene, and the like, barrier properties such as oxygen barrier properties and water vapor barrier properties are required. Therefore, containers often comprise packaging materials having barrier layers. However, on the other hand, for plugs, ports, and tubes to be attached to containers, it cannot be said that measures to provide barrier properties are sufficiently taken. Therefore, even if a container has barrier properties, it is difficult to say that sufficient barrier properties are ensured in terms of the entire plug-attached container.

Those in which the containers themselves have tubular structures such as tube for storing inks are also in a situation in which it is difficult to say that measures to provide barrier properties are sufficiently taken.

For these problems, some measures to inhibit degradation due to gas transmission and enhance the storage properties are proposed (for example, see Japanese Patent Laid-Open No. 2012-162272, Japanese Patent Laid-Open No. 2006-1623, and Japanese Patent Laid-Open No. 2004-66477).

From the viewpoint of the suppression of the degradation of the contents in a container, and the like, oxygen barrier properties for preventing oxidative degradation, and water vapor barrier properties for preventing drying and moisture absorption degradation are also required, but barrier properties for preventing the flavor, fragrance, and in addition volatile components of contents from flowing out of the container are also important. However, the barrier properties specifically taken as a problem in the above conventional art are oxygen barrier properties and water vapor barrier properties, and it is difficult to say that barrier properties for the components of contents are sufficiently studied.

The present invention has been made in view of the above problem, and it is an object of the present invention to provide a cylindrical molded article that can inhibit the transmission of components having SP values in a relatively wide range.

### SUMMARY OF THE INVENTION

The present inventors have studied diligently in order to solve the above problem, and as a result found that the above problem can be solved by using a resin having predetermined barrier performance and a resin having a predetermined solubility parameter for a layer structure, leading to the completion of the present invention.

Specifically, the present invention is as follows.

[1]

A cylindrical molded article comprising:

a cylindrical resin layer I comprising a vinylidene chloride copolymer; and

a cylindrical resin layer II disposed inside the resin layer I and comprising a resin having an SP value of 12.0 (cal/cm³)^{1/2} or more, and

having a total thickness of 100 μm or more.

[2]

The cylindrical molded article according to [1], wherein a content of vinylidene chloride constituting the vinylidene chloride copolymer is 85% by mass or more, and

a weight average molecular weight of the vinylidene chloride copolymer is 5.0×10⁴ or more.

[3]

The cylindrical molded article according to [1] or [2], wherein a sum of thicknesses of the resin layer I and the resin layer II is 30% or more based on a total thickness of the cylindrical molded article of 100%.

[4]

The cylindrical molded article according to any one of [1] to [3], wherein an SP value of a resin constituting the resin layer I is 10 to 11.5 (cal/cm³)^{1/2}.

[5]

The cylindrical molded article according to any one of [1] to [4], wherein an oxygen transmission rate of the resin layer I is 10000 mL·μm/m²·24 hrs·MPa (23° C. and 65% RH) or less.

### Effect of the Invention

According to the present invention, it is possible to provide a cylindrical molded article that can inhibit the transmission of components having SP values in a relatively wide range.

### BRIEF DESCRIPTION OF THE DRAWINGS

FIG. 1 shows a cross-sectional view of a cylindrical molded article in the present embodiment cut in the axial direction and a cross-sectional view of the cylindrical molded article in the present embodiment cut in the direction orthogonal to the axial direction;

FIG. 2 shows a cross-sectional view showing a barrier plug in the present embodiment;

FIG. 3 shows a side view showing a tube port-attached infusion bag comprising a tube port in the present embodiment; and

FIG. 4 shows a cross-sectional view showing a writing implement comprising an tube for storing ink in the present embodiment.

### DETAILED DESCRIPTION OF THE PREFERRED EMBODIMENT

An embodiment of the present invention (hereinafter referred to as “the present embodiment”) will be described in detail below, but the present invention is not limited to this, and various modifications can be made without departing from the spirit thereof.

### [Cylindrical Molded Article]

The cylindrical molded article in the present embodiment has a cylindrical resin layer I comprising a vinylidene chloride copolymer; and a cylindrical resin layer II disposed inside the resin layer I and comprising a resin having an SP value of 12.0 (cal/cm³)^{1/2} or more, and has a total thickness of 100 μm or more. The “cylindrical molded article” is not particularly limited as long as it is a tubularly molded molded body having two or more openings.

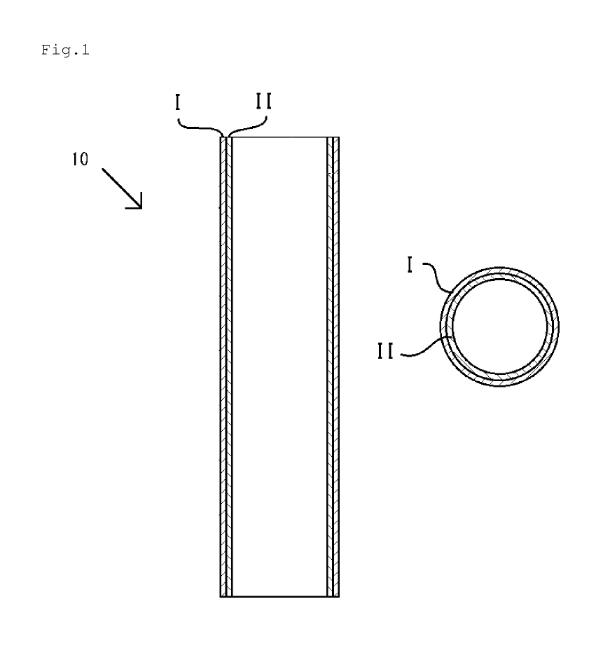

FIG. 1 shows a cross-sectional view of the cylindrical molded article in the present embodiment cut in the axial direction and a cross-sectional view of the cylindrical molded article in the present embodiment cut in the direction orthogonal to the axial direction. As shown in FIG. 1, the cylindrical molded article 10 in the present embodiment has a cylindrical resin layer I and a cylindrical resin layer II disposed inside the resin layer I. The mechanism that can inhibit the transmission of a substance from the inside of the cylindrical molded article to the outside when the cylindrical molded article has such a configuration is considered as follows.

First, in order for a substance to pass through a resin film, the substance needs to undergo the steps of the dissolution of the substance in the interior of the resin film, the diffusion of the substance in the interior of the resin film according to the concentration gradient, and the desorption of the substance from the opposite surface of the resin film. Here, for example, when the dissolution of the substance in the interior of the resin film is less likely to occur (when the affinity between the resin film and the substance is low), the amount of the substance going to the subsequent diffusion and desorption steps decreases. In addition, when the cohesive force of the resin constituting the resin film (the intermolecular forces between polymer chains, and the like) is strong, the substance is less likely to diffuse. Further, when the desorption of the substance from the resin film is less likely to occur (when the affinity between the resin film and the substance is high), the diffusion of the substance in the resin film and the subsequent desorption are less likely to proceed. When the cohesive force of the resin constituting the resin film (the intermolecular forces between polymer chains, and the like) is weak even if the dissolution of the substance in the interior of the resin film is less likely to occur (when the affinity between the resin film and the substance is low), it can be considered that there are pores through which the substance can pass at the molecular level, and as a result, the barrier properties are not equal to or higher than a certain level. In this manner, for the substance transmission properties of a resin film, it is necessary to combinedly consider various properties. In the present embodiment, the “barrier properties” refer to properties in which a substance is less likely to pass through a resin layer or resin layers.

In this respect, in the present embodiment, the cylindrical resin layer II comprising a resin having a relatively high SP value can be grasped as a layer having a low affinity for substances having low SP values and can be said to be a layer in which the dissolution of a substance in the interior of the resin film is less likely to occur, and the amount of the substance going to the subsequent diffusion and desorption steps is small. In addition, the resin layer I disposed outside the resin layer II comprises a vinylidene chloride copolymer having a strong cohesive force and is therefore configured so that a substance is less likely to diffuse in the resin layer I even if the substance passes from the resin layer II side. Therefore, in the present embodiment, by providing a structure that reduces the amount of a substance reaching the resin layer I and also does not allow the substance reaching the resin layer I to pass, further improvement of barrier properties can be promoted. Also when a substance having a high SP value goes to the steps of dissolution, diffusion, and desorption for the cylindrical resin layer II comprising the resin having a relatively high SP value, the substance has a low affinity for the resin layer I and is therefore less likely to diffuse, and the barrier properties can be improved.

### [Resin Layer I]

The resin layer I is a tubular layer provided outside the resin layer II in the cylindrical molded article. The resin layer I may comprise or be composed of a vinylidene chloride copolymer as the resin constituting the layer, but is preferably composed of a vinylidene chloride copolymer from the viewpoint of barrier property improvement. A plurality of resin layers I may be formed in the cylindrical molded article.

### (Vinylidene Chloride Copolymer)

The monomer copolymerizable with the vinylidene chloride monomer in the vinylidene chloride copolymer (hereinafter sometimes referred to as a “comonomer”) is not particularly limited, and examples thereof include vinyl chloride; acrylates such as methyl acrylate and butyl acrylate; acrylic acid; methacrylates such as methyl methacrylate and butyl methacrylate; methacrylic acid; methylacrylonitrile; and vinyl acetate. Among these, vinyl chloride, acrylates, and methylacrylonitrile are preferred from the viewpoint of the balance between barrier properties and extrusion processability. One of these copolymerizable monomers may be used alone, or two or more of these copolymerizable monomers may be used in combination.

The content of vinylidene chloride constituting the vinylidene chloride copolymer is preferably 85% by mass or more, more preferably 90% by mass or more and less than 100% by mass, and further preferably 95% by mass or more and less than 100% by mass. When the content of vinylidene chloride constituting the vinylidene chloride copolymer is 85% by mass or more, the barrier properties tend to improve more, and the degradation of contents at room temperature and at high temperature tends to be more inhibited.

The comonomer content of a vinylidene chloride-acrylate copolymer, a vinylidene chloride-methacrylate copolymer, and a vinylidene chloride-methylacrylonitrile copolymer is preferably 1 to 35% by mass, more preferably 1 to 25% by mass, further preferably 2 to 15.5% by mass, still further preferably 2 to 10% by mass, still more preferably 4 to 10% by mass, and particularly preferably 5 to 8% by mass. When the comonomer content in the vinylidene chloride copolymer is 1% by mass or more, the melting properties during extrusion tend to improve more. When the comonomer content of the vinylidene chloride copolymer is 35% by mass or less, the barrier properties tend to improve more, and the degradation of contents at room temperature and at high temperature tends to be more inhibited.

The comonomer content of a vinylidene chloride-vinyl chloride copolymer is preferably 1 to 40% by mass, more preferably 1 to 30% by mass, further preferably 1 to 21% by mass, still further preferably 3.5 to 18.5% by mass, still more preferably 6 to 16% by mass, and particularly preferably 8.5 to 15.0% by mass. When the comonomer content of the vinylidene chloride copolymer is 1% by mass or more, the melting properties during extrusion tend to improve more. When the comonomer content of the vinylidene chloride copolymer is 40% by mass or less, the barrier properties tend to improve more, and the degradation of contents at room temperature and at high temperature tends to be more inhibited.

The weight average molecular weight (Mw) of the vinylidene chloride copolymer is preferably 5.0×10⁴ or more, more preferably 6.0×10⁴ to 1.5×10⁵, and further preferably 7.0×10⁴ to 1×10⁵. When the weight average molecular weight (Mw) is 5.0×10⁴ or more, the melting properties during extrusion tend to improve more. When the weight average molecular weight (Mw) is 1.5×10⁵ or less, melt extrusion in which thermal stability is maintained tends to be possible. In the present embodiment, the weight average molecular weight (Mw) can be obtained by a gel permeation chromatography method (GPC method) using a standard polystyrene calibration curve.

### (SP Value)

The SP value of the resin constituting the resin layer I is preferably 10 to 11.5 (cal/cm³)^{1/2}, more preferably 10.2 to 11.4 (cal/cm³)^{1/2}, and further preferably 10.4 to 11.3 (cal/cm³)^{1/2}. When the SP value of the resin constituting the resin layer I is within the above range, the deviation of the SP value increases for the resin layer II, and the barrier properties tend to improve more. When the resin constituting the resin layer I comprises the vinylidene chloride copolymer, “the SP value of the resin constituting the resin layer I” described above is taken as the SP value of the whole of the resins constituting the resin layer I. When the resin layer I is composed of the vinylidene chloride copolymer, “the SP value of the resin constituting the resin layer I” described above is read as the SP value of the vinylidene chloride copolymer. The SP value can be controlled by adjusting the selection of the resin, and the content of the comonomer of the vinylidene chloride copolymer.

In the present embodiment, the “SP value” means a Solubility Parameter. In the present embodiment, the solubility parameter (SP value) means an amount defined by the following formula when cohesive energy density is ΔE (cal/mol), and molecular volume is V (cm³/mol), and means a value calculated using Fedor's calculation method shown below.

SP valueδ((cal/cm³)^{1/2})=(ΔE/ΔV)²

Fedor considered that both cohesive energy density and molar molecular volume depended on the type and number of substituents, and proposed a constant as shown in R. F. Fedors, Polym. Eng. Sci., 14[2] 147 (1974). The SP values of substances having similar properties tend to be similar, and those having closer SP values tend to be more easily compatible. By calculating and comparing SP values, mutual solubility can be evaluated. For the SP value, and the way of obtaining it, for each specific resin, those conventionally known can be appropriately considered.

Solubility parameters have been researched so far by various researchers, and also for calculation methods, in addition to Fedor's calculation method described above, Hansen's calculation method, Small's calculation method, and the like are known. For values calculated by these calculation methods, SP values calculated by different calculation methods cannot be simply compared with each other because the calculation methods are different. As an example, when the mutual solubility of a substance A and a substance B is evaluated, it is necessary to compare after calculating the respective SP values of the substance A and the substance B by the same Fedor's calculation method.

### (Oxygen Transmission Rate)

The oxygen transmission rate of the resin layer I at 23° C. and 65% RH is preferably 10000 mL·μm/m²·24 hrs·MPa or less, more preferably 1000 mL·μm/m²·24 hrs·MPa or less, and further preferably 100 mL·μm/m²·24 hrs·MPa or less. The lower limit of the oxygen transmission rate of the resin layer I at 23° C. and 65% RH is not particularly limited and is 0 mL·μm/m²·24 hrs·MPa (detection limit). As used herein, “RH” means relative humidity.

When the oxygen transmission rate of the resin layer I at 23° C. and 65% RH is 10000 mL·μm/m²·24 hrs·MPa or less, the oxygen barrier properties of the cylindrical molded article tend to improve more, and the degradation of contents, and the like tend to be more inhibited. The oxygen transmission rate of the resin layer I at 23° C. and 65% RH can be decreased by appropriately selecting and using the resin constituting the resin layer I. The oxygen transmission rate of the resin layer I at 23° C. and 65% RH can be measured by a method described in Examples.

### (Water Vapor Transmission Rate)

The water vapor transmission rate of the resin layer I at 38° C. and 90% RH is preferably 1000 g·μm/m²·24 hrs·MPa or less, more preferably 100 g·μm/m²·24 hrs·MPa or less, and further preferably 10 g·μm/m²·24 hrs·MPa or less. The lower limit of the water vapor transmission rate of the resin layer I at 38° C. and 90% RH is not particularly limited and is 0 g·μm/m²·24 hrs·MPa (detection limit).

When the water vapor transmission rate of the resin layer I at 38° C. and 90% RH is 1000 g·μm/m²·24 hrs·MPa or less, the water vapor barrier properties of the cylindrical molded article tend to improve more, and the degradation of contents, and the like tend to be more inhibited. The water vapor transmission rate of the resin layer I at 38° C. and 90% RH can be decreased by appropriately selecting and using the resin constituting the resin layer I. The water vapor transmission rate of the resin layer I at 38° C. and 90% RH can be measured by a method described in Examples.

### (Thickness)

The thickness of the resin layer I is preferably 10 to 300 μm, more preferably 20 to 200 μm, and further preferably 30 to 100 μm. When the thickness of the resin layer I is 300 μm or less, the resin layer I can be thinly formed. Therefore, the wall thickness of the cylindrical molded article decreases, which is advantageous when the cylindrical molded article is used for various applications. Specifically, when the cylindrical molded article is used as a plug such as a spout, the inner diameter of the discharge flow path can be increased without changing the outer shape size of the plug. When the cylindrical molded article is used as an tube for storing ink, the amount of the ink that can be accommodated tends to be able to be increased without changing its outer shape size. When the thickness of the resin layer I is 10 μm or more, various barrier properties improve more, and the degradation of contents at room temperature and at high temperature tends to be more inhibited.

### [Resin Layer II]

The resin layer II is a tubular layer provided inside the resin layer I in the cylindrical molded article. The resin layer II may comprise or be composed of a resin having an SP value of 12.0 (cal/cm³)^{1/2} or more as the resin constituting the layer, but is preferably composed of a resin having an SP value of 12.0 (cal/cm³)^{1/2} or more from the viewpoint of barrier property improvement. A plurality of resin layers II may be formed in the cylindrical molded article.

### (SP Value)

The SP value of the resin constituting the resin layer II is preferably 12.0 (cal/cm³)^{1/2} or more, more preferably 12.0 to 20.0 (cal/cm³)^{1/2}, and further preferably 12.2 to 16.0 (cal/cm³)^{1/2}. When the SP value of the resin constituting the resin layer II is within the above range, the affinity for nonpolar substances decreases more, and as a result, the solubility of nonpolar substances in the resin layer II tends to decrease more. The SP value can be controlled by adjusting the selection of the resin, and the content of the comonomer of the vinylidene chloride copolymer.

As the resin satisfying the above SP value, a known one can be appropriately used, and the resin satisfying the above SP value is not particularly limited. Examples of the resin satisfying the above SP value as a homopolymer include polyamides such as nylon 66 (11.2); polyacrylonitriles such as polyacrylonitrile (14.4); polyesters such as polyethylene terephthalate (12.4); ethylene vinyl alcohol (14.0); and celluloses such as cellulose acetate (12.4) and cellulose (19.8).

### (Thickness)

The thickness of the resin layer II is preferably 10 to 300 μm, more preferably 30 to 200 μm, and further preferably 50 to 150 μm. When the thickness of the resin layer II is 300 μm or less, the resin layer II can be thinly formed. Therefore, the wall thickness of the cylindrical molded article decreases, which is advantageous when the cylindrical molded article is used for various applications. Specifically, when the cylindrical molded article is used as a plug such as a spout, the inner diameter of the discharge flow path can be increased without changing the outer shape size of the plug. When the cylindrical molded article is used as an tube for storing ink, the amount of the ink that can be accommodated tends to be able to be increased without changing its outer shape size. When the thickness of the resin layer II is 50 μm or more, various barrier properties improve more, and the degradation of contents at room temperature and at high temperature tends to be more inhibited.

The sum of the thicknesses of the resin layer I and the resin layer II is preferably 30% or more, more preferably 40% or more, and further preferably 50% or more based on a total thickness of the cylindrical molded article of 100%. When the sum of the thicknesses of the resin layer I and the resin layer II is 30% or more, various barrier properties tend to improve more. The upper limit of the sum of the thicknesses of the resin layer I and the resin layer II is not particularly limited but is preferably 100% or less based on a total thickness of the cylindrical molded article of 100%.

### [Resin Layer III]

The cylindrical molded article in the present embodiment may further have a resin layer III not applicable to the above resin layers I and II.

Specifically, the cylindrical molded article in the present embodiment may further have the resin layer III comprising a resin other than a vinylidene chloride copolymer and a resin having an SP value of 12.0 (cal/cm³)^{1/2} or more. A plurality of resin layers III may be formed in the cylindrical molded article. The cylindrical molded article in the present embodiment may have another resin layer II.

Such a resin is not particularly limited, and examples thereof include polyethylene-based resins such as low density polyethylene, medium density polyethylene, high density polyethylene, and ethylene-α-olefins; polypropylene-based resins such as homopolypropylene, random polypropylene, and block polypropylene; cyclic olefin resins such as cycloolefin polymers; polycarbonates; polyester-based resins such as polyethylene terephthalate and polybutylene terephthalate; polystyrene; acrylate-based resins such as polybutyl acrylate; methacrylate-based resins such as polymethyl methacrylate and polybutyl methacrylate; acrylic-styrene copolymers; and polymethylpentene resins.

The thickness of the resin layer III is preferably 10 to 300 μm, more preferably 30 to 200 μm, and further preferably 50 to 150 μm.

### (Other Additives)

The above resin layers may comprise other additives such as a known plasticizer, heat stabilizer, colorant, organic lubricant, inorganic lubricant, surfactant, processing aid, antimicrobial agent, and antioxidant as required.

The plasticizer is not particularly limited, and examples thereof include acetyl tributyl citrate, acetylated monoglycerides, and dibutyl sebacate.

The heat stabilizer is not particularly limited, and examples thereof include epoxidized vegetable oils such as epoxidized soybean oil and epoxidized linseed oil, epoxy-based resins, magnesium oxide, and hydrotalcite.

### [Total Thickness]

The total thickness of the cylindrical molded article is 100 μm or more, preferably 200 μm or more, and more preferably 300 μm or more. When the total thickness of the cylindrical molded article is 100 μm or more, various barrier properties improve more, and the degradation of contents at room temperature and at high temperature tends to be more inhibited. The upper limit of the total thickness of the cylindrical molded article is preferably 1500 μm or less, more preferably 1000 μm or less, and further preferably 750 μm or less. When the total thickness of the cylindrical molded article is 1500 μm or less, the wall thickness of the cylindrical molded article decreases, which is advantageous when the cylindrical molded article is used for various applications. Specifically, when the cylindrical molded article is used as a plug such as a spout, the inner diameter of the discharge flow path can be increased without changing the outer shape size of the plug. When the cylindrical molded article is used as an tube for storing ink, the amount of the ink that can be accommodated tends to be able to be increased without changing its outer shape size.

### [Layer Configuration]

As long as the cylindrical molded article in the present embodiment has a configuration in which the resin layer II is disposed inside the resin layer I, other layer configurations are not particularly limited. For example, the following configurations are considered. The expression “resin layer II/resin layer I” indicates that the resin layer II and the resin layer I are laminated from the inside of the cylindrical molded article toward the outside.

resin layer II/resin layer I

resin layer II/resin layer I/resin layer III

resin layer II/resin layer III/resin layer I

resin layer II/resin layer III/resin layer I/resin layer III

resin layer III/resin layer II/resin layer I

resin layer III/resin layer II/resin layer I/resin layer III

resin layer III/resin layer II/resin layer III/resin layer I

resin layer III/resin layer II/resin layer III/resin layer I/resin layer III

resin layer II/resin layer I/resin layer II/resin layer I

### (Oxygen Transmission Rate)

The oxygen transmission rate of the cylindrical molded article at 23° C. and 65% RH is preferably 10000 mL·μm/m²·24 hrs·MPa or less, more preferably 1000 mL·μm/m²·24 hrs·MPa or less, and further preferably 100 mL·μm/m²·24 hrs·MPa or less. The lower limit of the oxygen transmission rate of the cylindrical molded article at 23° C. and 65% RH is not particularly limited and is 0 mL·μm/m²·24 hrs·MPa (detection limit). As used herein, “RH” means relative humidity.

When the oxygen transmission rate of the cylindrical molded article at 23° C. and 65% RH is 10000 mL·μm/m²·24 hrs·MPa or less, the oxygen barrier properties of the cylindrical molded article tend to improve more, and the degradation of contents, and the like tend to be more inhibited. The oxygen transmission rate of the cylindrical molded article at 23° C. and 65% RH can be decreased by appropriately selecting and using the resin constituting the resin layer I, and resins constituting other layers. The oxygen transmission rate of the cylindrical molded article at 23° C. and 65% RH can be measured by a method described in Examples.

### (Water Vapor Transmission Rate)

The water vapor transmission rate of the cylindrical molded article at 38° C. and 90% RH is preferably 1000 g·μm/m²·24 hrs·MPa or less, more preferably 100 g·μm/m²·24 hrs·MPa or less, and further preferably 10 g·μm/m²·24 hrs·MPa or less. The lower limit of the water vapor transmission rate of the cylindrical molded article at 38° C. and 90% RH is not particularly limited and is 0 g·μm/m²·24 hrs·MPa (detection limit).

When the water vapor transmission rate of the cylindrical molded article at 38° C. and 90% RH is 1000 g·μm/m^{2·}24 hrs·MPa or less, the water vapor barrier properties of the cylindrical molded article tend to improve more, and the degradation of contents, and the like tend to be more inhibited. The water vapor transmission rate of the cylindrical molded article at 38° C. and 90% RH can be decreased by appropriately selecting and using the resin constituting the resin layer I, and resins constituting other layers. The water vapor transmission rate of the cylindrical molded article at 38° C. and 90% RH can be measured by a method described in Examples.

### [Method for Manufacturing Cylindrical Molded Article]

The method for manufacturing a cylindrical molded article in the present embodiment has the extrusion step of extruding resins constituting resin layers I and II to mold a cylindrical molded article having cylindrically laminated resin layers. The extrusion method for the cylindrical resin layers is not particularly limited, and a conventionally known method can be used.

### [Applications]

The cylindrical molded article in the present embodiment can be preferably used as a barrier plug and a liquid transport tube provided in a container for accommodating a food or the like, a barrier plug and a liquid transport tube provided in a container for accommodating a drug or the like, and in addition a barrier plug and a liquid transport tube provided in a container for accommodating a product other than a food and a drug, and an tube for storing ink for a ballpoint pen, a highlighter, or the like. In the present embodiment, the “container” is not particularly limited as long as it is configured to be able to accommodate contents. A bag and the like are also included in the concept of the container.

### [Barrier Plug]

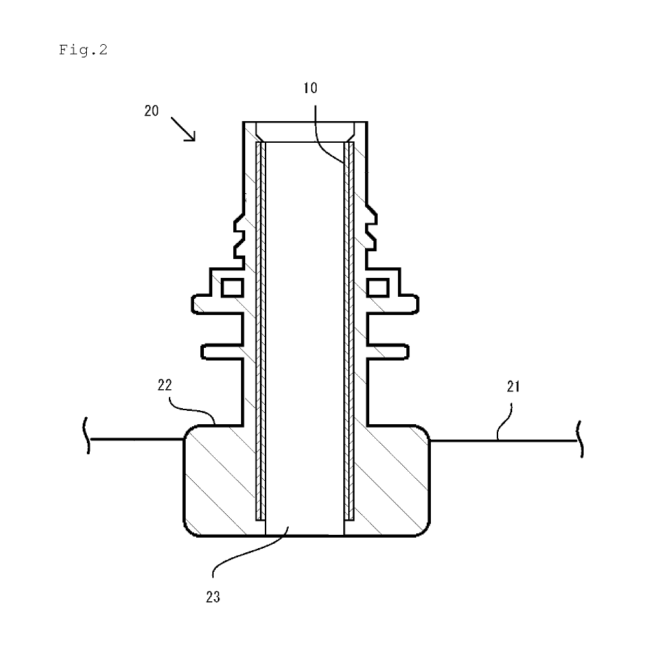

The barrier plug in the present embodiment has a spout body to be attached to a container, and a cylindrical molded article inserted into the spout body, the cylindrical molded article is the above cylindrical molded article, and the above spout body comprises a polyolefin-based resin. FIG. 2 shows a cross-sectional view showing a barrier plug. A barrier plug 20 has a spout body 22 to be attached to a container 21, and the above cylindrical molded article 10 inserted into the spout body 22, and the cylindrical molded article forms a discharge flow path 23 for discharging the contents in the container to the outside. Such a barrier plug 20 can be manufactured, for example, by injection-molding the resin constituting the spout body 22 around the cylindrical molded article 10, though not particularly limited.

The resin constituting the spout body is not particularly limited, and examples thereof include polyethylene-based resins (hereinafter also referred to as “PE”) such as low density polyethylene, medium density polyethylene, high density polyethylene, and ethylene-α-olefins; polypropylene-based resins (hereinafter also referred to as “PP”) such as homopolymers or copolymers such as random copolymers and block copolymers; ethylene-vinyl acetate copolymers (hereinafter abbreviated as EVA); polyamide-based resins (hereinafter also referred to as “PA”); and adhesive resins. Among these, polyolefin-based resins are preferred.

### [Barrier Plug-Attached Container]

The barrier plug-attached container in the present embodiment has a container and the above barrier plug attached to the container. As the container, one comprising at least one or more selected from the group consisting of a laminated film having a resin layer having an oxygen transmission rate of 1000 mL·μm/m²·24 hrs·MPa (23° C. and 65% RH) or less and a water vapor transmission rate of 1000 g·μm/m²·24 hrs·MPa (38° C. and 90% RH) or less, a laminated film having an aluminum foil layer, and a metal vapor-deposited film is preferred.

The constituent member of the container is not particularly limited, and examples thereof include at least one or more selected from the group consisting of a laminated film having a resin layer having an oxygen transmission rate of 1000 mL·μm/m²·24 hrs·MPa (23° C. and 65% RH) or less and a water vapor transmission rate of 1000 g·μm/m²·24 hrs·MPa (38° C. and 90% RH) or less, a laminated film having an aluminum foil layer, and a metal vapor-deposited film. A barrier plug-attached container having such a container and a barrier plug attached to the container is also included in the scope of the present embodiment.

The “container” is not particularly limited, and examples thereof include plug-attached containers, plug-attached bags, and plug-attached bottles in which drinks, jellies, seasonings such as soy sauce, or the like are enclosed. Problems of conventional plugs are that they have poor oxygen barrier properties and/or water vapor barrier properties, and therefore even if containers for accommodating foods or the like have oxygen barrier properties and water vapor barrier properties in themselves, oxygen and water vapor passing through the plugs degrade the accommodated product in the packaging, and conversely, the components in the contents of the packaging are released to the outside through the plugs. In a food packaging step, from the viewpoint of sterilization and disinfection, a food to be packaged is enclosed in a container in a heated state, or a container in which a food is enclosed is heated. However, a problem is that when the plug is exposed to water vapor produced from the food or the like in the food packaging step, the barrier properties decrease further. In contrast to this, the barrier plug in the present embodiment can inhibit the degradation of a food or the like in packaging by comprising the cylindrical molded article.

### [Infusion Bag Port]

The port in the present embodiment is a port to be attached to an infusion bag and comprises the above cylindrical molded article. The types of ports include a port of a type in which its end is closed by a closure plug such as an elastic body configured so that it can be pierced with a hollow needle and a liquid does not leak from a gap formed by sticking (hereinafter also referred to as a “closure plug type port”), and a tube type port to which a twist-off type connector whose upper portion is twisted and opened, a branch type connector, a cap-attached connector, or the like can be connected instead of a closure plug (hereinafter also referred to as a “tube port”). The “tube port” refers to, among plugs that are flow paths for liquids in infusion bags, one having an end to which an infusion bag is to be adhered (welded) (hereinafter also referred to as “an end in an infusion bag”), and an end configured so that it is exposed to the outside of the infusion bag and various connectors or the like can be connected (hereinafter also referred to as a “connector connection end”), and the “tube port” is distinguished from the closure plug type port in this respect.

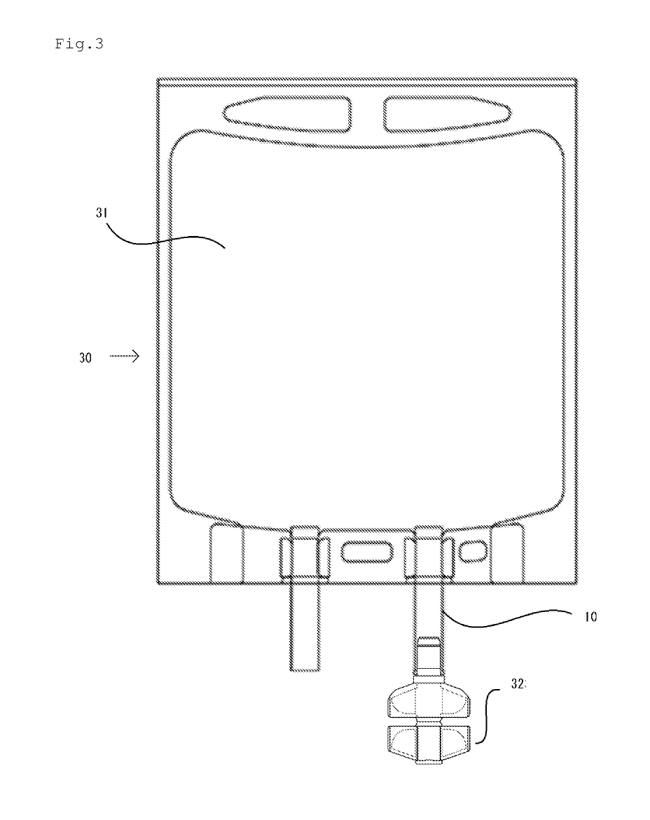

FIG. 3 shows a side view showing a tube port-attached infusion bag comprising a tube port. One end of a cylindrical molded article 10 (the end in the infusion bag) is connected and welded to the infusion bag 31, and a connector 32 is connected to the other end (connector connection end).

The “infusion bag” is not particularly limited, and examples thereof include packaging in which blood, drops, water, electrolytes, nutrients, or the like are enclosed. Problems of conventional plugs and liquid transport tubes are that they have poor oxygen barrier properties and/or water vapor barrier properties, and therefore even if containers for accommodating drugs or the like have oxygen barrier properties and water vapor barrier properties in themselves, oxygen and water vapor passing through the plugs degrade the contents of the packaging, and conversely, the components in the contents of the packaging are released to the outside through the plugs. In a drug packaging step, from the viewpoint of sterilization and disinfection, a drug to be packaged is enclosed in a container in a heated state, or a container in which a drug is enclosed is heated. However, a problem is that when the plug is exposed to water vapor produced from the drug or the like in the drug packaging step, the barrier properties decrease further. In contrast to this, the barrier plug in the present embodiment can prevent the adsorption of nutrients or the like on a container and inhibit the degradation of a drug or the like in packaging by comprising the cylindrical molded article.

### [Tube for Storing Ink]

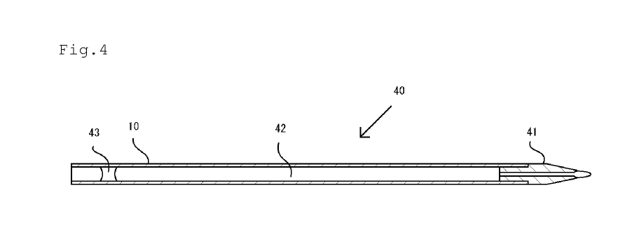

The tube for storing ink in the present embodiment is an tube for storing ink for accommodating a writing implement ink, and the tube for storing ink is the above cylindrical molded article. FIG. 4 shows a schematic cross-sectional view showing a writing implement comprising the tube for storing ink in the present embodiment. A writing implement 40 comprising the tube for storing ink 10 in the present embodiment has a pen point 41 at one end of the tube for storing ink 10 and has a sealing body 43 for enclosing an ink in an ink-accommodating section 42 at the other end. Writing implements include an inner cotton type and a direct liquid type as classification by the structure in the accommodating vessel, and brushes, soft pens, and hard pens as classification by the type of pen point. The tube for storing ink in the present embodiment can be used for all. The specific types are not particularly limited, and examples thereof include fountain pens, ballpoint pens, markers, felt-tipped pens, felt pens, calligraphy pens, and refills therefor.

The tube for storing ink can be configured so that by pressurization in the ink-accommodating section 42, the ink is guided to the pen point to allow writing. A problem of conventional tube for storing inks is that they have poor oxygen barrier properties and/or water vapor barrier properties, and therefore the pressure of the space 23 decreases with time. In contrast to this, the tube for storing ink in the present embodiment can inhibit the transmission and degradation of the ink components in the tube for storing ink and prevent quality degradation such as insufficient ink ejection by comprising the cylindrical molded article.

### [Liquid Transport Tube]

The liquid transport tube in the present embodiment is composed of the above cylindrical molded article. The liquid transport tube forms a discharge flow path for discharging contents in a container to the outside. Its applications are not particularly limited, and examples thereof include those used by being connected to the above foods or medical infusion bags.

### EXAMPLES

The present invention will be more specifically described below using Examples and Comparative Examples. The present invention is not limited by the following Examples in any way.

### [Fabrication of Substitute Measurement Samples for Measuring Oxygen Transmission Rates and Water Vapor Transmission Rates]

In the measurement of the oxygen transmission rates and water vapor transmission rates of a cylindrical molded article and a resin layer I, a substitute measurement sample that was a multilayer film imitating the layer structure (the types of resins, lamination order, and the thickness ratio of layers) of the cylindrical molded article, and a substitute measurement sample that was a single-layer film of only the resin layer I used in the cylindrical molded article were each fabricated, and from the measured values of the oxygen transmission rates and water vapor transmission rates of the substitute measurement samples, the oxygen transmission rates and water vapor transmission rates of the cylindrical molded article and the resin layer I were calculated.

The substitute measurement film for the cylindrical molded article was obtained by forming such a multilayer film as to have the same layer configuration ratio as the cylindrical molded article with the thickness of the layers being 1/10 of that of the cylindrical molded article, using a direct inflation apparatus and using a coextrusion multilayer die. The substitute measurement film for the resin layer I was obtained by forming a film so that the thickness of the layer was 25 μm, using a direct inflation apparatus and using a single-layer die. A “substitute measurement film for the cylindrical molded article” and a “substitute measurement film for the resin layer I” hereinafter refer to films having the above configurations.

The oxygen transmission rate and the water vapor transmission rate per thickness of each of these substitute measurement films were measured, and the obtained measured values were multiplied by the thickness of each substitute measurement film to obtain the oxygen transmission rate and the water vapor transmission rate per thickness of 1 μm. Barrier properties can be evaluated higher as various transmission rates per thickness of 1 μm become smaller, and therefore by comparing various transmission rates per thickness of 1 μm, various barrier properties when the thickness of the substitute measurement films was converted into the thickness of the cylindrical molded article or the thickness of the resin layer I can be evaluated.

transmission rate per thickness of 1 μm=transmission rate of substitute measurement film×thickness of substitute measurement film

### [Oxygen Transmission Rate (OTR)]

The oxygen transmission rate (OTR) was measured in accordance with ASTM D-3985. Specifically, a substitute measurement sample having a predetermined thickness was measured under the conditions of 23° C. and 65% RH using Mocon OX-TRAN 2/20. The obtained measured value was multiplied by the thickness of the cylindrical molded article or the resin layer I to obtain the oxygen transmission rate per thickness of 1 μm (rounded to the nearest whole number). The unit of the oxygen transmission rate (mL·μm/m²·24 hrs·MPa) represents the oxygen transmission rate per thickness of 1 μm.

### [Water Vapor Transmission Rate (WVTR)]

The water vapor transmission rate (WVTR) was measured in accordance with ASTM F-372. Specifically, a substitute measurement sample having a predetermined thickness was measured under the conditions of 38° C. and 90% RH using Mocon PERMATRAN-W398. The obtained measured value was multiplied by the thickness of the cylindrical molded article or the resin layer I to obtain the water vapor transmission rate per thickness of 1 μm (rounded to the nearest whole number). The unit of the water vapor transmission rate (g·μm/m²·24 hrs·MPa) represents the water vapor transmission rate per thickness of 1 μm.

### [Smell Retention Property Evaluation]

1 g of each of trimethylamine (SP value: 6.9 (cal/cm³)^{1/2}), limonene (SP value: 8.6 (cal/cm³)^{1/2}), L-menthol (SP value: 9.6 (cal/cm³)^{1/2}), and methyl salicylate (SP value: 13.7 (cal/cm³)^{1/2}) was placed in tubular molded bodies obtained in the Examples and the Comparative Examples, and hermetically sealed by putting in plugs made of aluminum. The tubular molded bodies were placed in 5 L desiccators in a state in which the tube side surfaces were horizontal, and hermetically sealed. After the desiccators were stored at 40° C. for 1 day, the degrees of the smell of the various reagents leaking from the tubular molded bodies into the desiccators were evaluated by the following criteria.

◯: there was no smell at all

Δ: a faint smell was felt

X: there was a distinct smell

### Example 1

An MXD6 polyamide resin (PA; SP value 13.5 (cal/cm³)^{1/2}, manufactured by MITSUBISHI GAS CHEMICAL COMPANY, INC., product name S6007), an adhesive resin (Glue; manufactured by Mitsui Chemicals, Inc., product name ADMER SE810), a vinylidene chloride copolymer (VC11; vinylidene chloride (VDC)/vinyl chloride (VC)=89/11 (% by mass), weight average molecular weight 8×10⁴, SP value 11.2 (cal/cm³)^{1/2}, manufactured by Asahi Kasei Corporation), the adhesive resin (Glue), and low density polyethylene (PE; manufactured by Asahi Kasei Corporation, product name F1920) were continuously extruded tubularly so as to form layers in this order from the inside, using melt extrusion equipment equipped with a coextrusion multilayer tubular die. Then, the coextrudate was adjusted to an outer diameter of 10 mm in a cold water tank with an outer diameter sizing apparatus to obtain a cylindrical molded article having a five-layer structure having a thickness of 330 μm. A substitute measurement film for the cylindrical molded article having a thickness of 33 μm, and a substitute measurement film for the resin layer I having a thickness of 25 μm were obtained using the same resins.

### Example 2

A cylindrical molded article having a five-layer structure having an outer diameter of 10 mm and a thickness of 330 μm, and a substitute measurement film for the cylindrical molded article having a thickness of 33 μm, and a substitute measurement film for the resin layer I having a thickness of 25 μm were obtained as in Example 1 except that the adhesive resin (Glue) corresponding to the fourth layer counted in order from the inside layer was changed to an ethylene-vinyl acetate copolymer (EVA; manufactured by Nippon Unicar Company Limited, product name NUC3765D).

### Example 3

The MXD6 polyamide resin (PA), the adhesive resin (Glue), a vinylidene chloride copolymer (MA5; vinylidene chloride (VDC)/methyl acrylate (MA)=95/5 (% by mass), weight average molecular weight 8×10⁴, SP value 11.2 (cal/cm³)^{1/2}, manufactured by Asahi Kasei Corporation), the adhesive resin (Glue), and homopolypropylene (PP; manufactured by SunAllomer Ltd., product name PL500A) were continuously extruded tubularly so as to form layers in this order from the inside, using melt extrusion equipment equipped with a coextrusion multilayer tubular die. Then, the coextrudate was adjusted to an outer diameter of 10 mm in a cold water tank with an outer diameter sizing apparatus to obtain a cylindrical molded article having a five-layer structure having a thickness of 330 μm. A substitute measurement film for the cylindrical molded article having a thickness of 33 μm, and a substitute measurement film for the resin layer I having a thickness of 25 μm were obtained using the same resins.

### Example 4

A cylindrical molded article having a five-layer structure having an outer diameter of 10 mm and a thickness of 290 μm, and a substitute measurement film for the cylindrical molded article having a thickness of 29 μm, and a substitute measurement film for the resin layer I having a thickness of 25 μm were obtained as in Example 3 except that the thickness of the adhesive resin (Glue) corresponding to the second and fourth layers counted in order from the inside layer was changed.

### Example 5

A cylindrical molded article having a five-layer structure having an outer diameter of 10 mm and a thickness of 100 μm, and a substitute measurement film for the cylindrical molded article having a thickness of m, and a substitute measurement film for the resin layer I having a thickness of 25 μm were obtained as in Example 3 except that the thicknesses of the layers were changed.

### Example 6

A cylindrical molded article having a five-layer structure having an outer diameter of 10 mm and a thickness of 330 μm, and a substitute measurement film for the cylindrical molded article having a thickness of 33 μm, and a substitute measurement film for the resin layer I having a thickness of 25 μm were obtained as in Example 3 except that a vinylidene chloride copolymer (MA8; vinylidene chloride (VDC)/methyl acrylate (MA)=92/8 (% by mass), weight average molecular weight 8×10⁴, SP value 11.2 (cal/cm³)^{1/2}, manufactured by Asahi Kasei Corporation) was used instead of the MA5 resin.

### Example 7

A cylindrical molded article having a five-layer structure having an outer diameter of 10 mm and a thickness of 600 μm, and a substitute measurement film for the cylindrical molded article having a thickness of 60 μm, and a substitute measurement film for the resin layer I having a thickness of 25 μm were obtained as in Example 6 except that the thicknesses of the layers were changed.

### Example 8

A cylindrical molded article having a five-layer structure having an outer diameter of 10 mm and a thickness of 330 μm, and a substitute measurement film for the cylindrical molded article having a thickness of 33 μm, and a substitute measurement film for the resin layer I having a thickness of 25 μm were obtained as in Example 3 except that a vinylidene chloride copolymer (MAN5; vinylidene chloride (VDC)/methylacrylonitrile (MAN)=95/5 (% by mass), weight average molecular weight 8×10⁴, SP value 11.3 (cal/cm³)^{1/2}, manufactured by Asahi Kasei Corporation) was used instead of the MA5 resin.

### Example 9

A cylindrical molded article having a five-layer structure having an outer diameter of 10 mm and a thickness of 330 μm, and a substitute measurement film for the cylindrical molded article having a thickness of 33 μm, and a substitute measurement film for the resin layer I having a thickness of 25 μm were obtained as in Example 3 except that polyethylene terephthalate (PET; SP value 12.4 (cal/cm³)^{1/2}, manufactured by TEIJIN LIMITED, product name TRN-8580FH) was used instead of the MXD6 polyamide resin (PA), the innermost layer.

### Example 10

A cylindrical molded article having a five-layer structure having an outer diameter of 10 mm and a thickness of 330 μm, and a substitute measurement film for the cylindrical molded article having a thickness of 33 μm, and a substitute measurement film for the resin layer I having a thickness of 25 μm were obtained as in Example 3 except that an ethylene-vinyl alcohol copolymer (EVOH; SP value 14.0 (cal/cm³)^{1/2}, manufactured by The Nippon Synthetic Chemical Industry Co., Ltd., product name Soarnol AT4403B) was used instead of the MXD6 polyamide resin (PA), the innermost layer.

### Comparative Example 1

Low density polyethylene (PE, SP value 8.6 (cal/cm³)^{1/2}), the ethylene-vinyl acetate copolymer (EVA), the VC11 resin (manufactured by Asahi Kasei Corporation), the ethylene-vinyl acetate copolymer (EVA), and low density polyethylene (PE) were continuously extruded tubularly so as to form layers in this order from the inside, using melt extrusion equipment equipped with a coextrusion multilayer tubular die. Then, the coextrudate was adjusted to an outer diameter of 10 mm in a cold water tank with an outer diameter sizing apparatus to obtain a cylindrical molded article having a five-layer structure having a thickness of 330 μm. A substitute measurement film for the cylindrical molded article having a thickness of 33 μm, and a substitute measurement film for the resin layer I having a thickness of 25 μm were obtained using the same resins.

### Comparative Example 2

Polyethylene terephthalate (PET), the adhesive resin (Glue), the ethylene-vinyl alcohol copolymer (EVOH), the adhesive resin (Glue), and homopolypropylene (PP) were continuously extruded tubularly so as to form layers in this order from the inside, using melt extrusion equipment equipped with a coextrusion multilayer tubular die. Then, the coextrudate was adjusted to an outer diameter of 10 mm in a cold water tank with an outer diameter sizing apparatus to obtain a cylindrical molded article having a five-layer structure having a thickness of 330 μm. A substitute measurement film for the cylindrical molded article having a thickness of 33 μm, and a substitute measurement film for the resin layer I having a thickness of 25 μm were obtained using the same resins.

### Comparative Example 3

A cylindrical molded article having a five-layer structure having an outer diameter of 10 mm and a thickness of 50 μm, and a substitute measurement film for the cylindrical molded article having a thickness of 5 μm, and a substitute measurement film for the resin layer I having a thickness of 25 μm were obtained as in Example 3 except that the thicknesses of the layers were changed.

TABLE 1

| | | | | | | | Sum of | | |
|---|---|---|---|---|---|---|---|---|---|
| | | | | | | | thicknesses of | | Oxygen |
| | | | | | | | resin layer I | | transmission |
| | Layer configuration inside → outside | | | | | | and resin | | rate of entire |
| | (thickness μm) | | | | | Total | layer II | | cylindrical |
| | [SP value] | | | | | thickness | μm | % | molded article |
| Example 1 | PA | Glue | VC11 | Glue | PE | 330 μm | 170 μm | 52 | 600 |
| | (100 μm) | (30 μm) | (70 μm) | (30 μm) | (100 μm) | | | | |
| | [13.5] | | [11.2] | | | | | | |
| Example 2 | PA | Glue | VC11 | EVA | PE | 330 μm | 170 μm | 52 | 600 |
| | (100 μm) | (30 μm) | (70 μm) | (30 μm) | (100 μm) | | | | |
| | [13.5] | | [11.2] | | | | | | |
| Example 3 | PA | Glue | MA5 | Glue | PP | 330 μm | 170 μm | 52 | 210 |
| | (100 μm) | (30 μm) | (70 μm) | (30 μm) | (100 μm) | | | | |
| | [13.5] | | [11.2] | | | | | | |
| Example 4 | PA | Glue | MA5 | Glue | PP | 290 μm | 170 μm | 59 | 210 |
| | (100 μm) | (10 μm) | (70 μm) | (10 μm) | (100 μm) | | | | |
| | [13.5] | | [11.2] | | | | | | |
| Example 5 | PA | Glue | MA5 | Glue | PP | 120 μm | 40 μm | 33 | 210 |
| | (10 μm) | (30 μm) | (30 μm) | (30 μm) | (20 μm) | | | | |
| | [13.5] | | [11.2] | | | | | | |
| Example 6 | PA | Glue | MA8 | Glue | PP | 330 μm | 170 μm | 52 | 400 |
| | (100 μm) | (30 μm) | (70 μm) | (30 μm) | (100 μm) | | | | |
| | [13.5] | | [11.2] | | | | | | |
| Example 7 | PA | Glue | MA8 | Glue | PP | 600 μm | 400 μm | 67 | 400 |
| | (100 μm) | (50 μm) | (300 μm) | (50 μm) | (100 μm) | | | | |
| | [13.5] | | [11.2] | | | | | | |
| Example 8 | PA | Glue | MAN5 | Glue | PP | 330 μm | 170 μm | 52 | 140 |
| | (100 μm) | (30 μm) | (70 μm) | (30 μm) | (100 μm) | | | | |
| | [13.5] | | [11.3] | | | | | | |
| Example 9 | PET | Glue | MA5 | Glue | PP | 330 μm | 170 μm | 52 | 205 |
| | (100 μm) | (30 μm) | (70 μm) | (30 μm) | (100 μm) | | | | |
| | [12.4] | | [11.2] | | | | | | |
| Example | EVOH | Glue | MA5 | Glue | PP | 330 μm | 170 μm | 52 | 170 |
| 10 | (100 μm) | (30 μm) | (70 μm) | (30 μm) | (100 μm) | | | | |
| | [14.0] | | [11.2] | | | | | | |
| Comparative | PE | EVA | VC11 | EVA | PE | 330 μm | 170 μm | 52 | 600 |
| Example 1 | (100 μm) | (30 μm) | (70 μm) | (30 μm) | (100 μm) | | | | |
| | [8.6] | | [11.2] | | | | | | |
| Comparative | PET | Glue | EVOH | Glue | PP | 330 μm | 170 μm | 52 | 135 |
| Example 2 | (100 μm) | (30 μm) | (70 μm) | (30 μm) | (100 μm) | | | | |
| | [12.4] | | [14.0] | | | | | | |
| Comparative | PA | Glue | MA5 | Glue | PP | 50 μm | 20 μm | 40 | 210 |
| Example 3 | (10 μm) | (10 μm) | (10 μm) | (10 μm) | (10 μm) | | | | |
| | [13.5] | | [11.2] | | | | | | |

| | Water vapor | | | Smell retention property evaluation | | | |
|---|---|---|---|---|---|---|---|
| | transmission | Oxygen | Water vapor | | | | Methyl |
| | rate of entire | transmission | transmission | Trimethylamine | Limonene | L-menthol | salicylate |
| | cylindrical | rate of only | rate of only | SP value: | SP value: | SP value: | SP value: |
| | molded article | resin layer I | resin layer I | 6.9 | 8.6 | 9.6 | 13.7 |
| Example 1 | 40 | 600 | 40 | ◯ | ◯ | ◯ | ◯ |
| Example 2 | 40 | 600 | 40 | ◯ | ◯ | ◯ | ◯ |
| Example 3 | 20 | 210 | 20 | ◯ | ◯ | ◯ | ◯ |
| Example 4 | 20 | 210 | 20 | ◯ | ◯ | ◯ | ◯ |
| Example 5 | 20 | 210 | 20 | ◯ | ◯ | Δ | ◯ |
| Example 6 | 30 | 400 | 30 | ◯ | ◯ | ◯ | ◯ |
| Example 7 | 30 | 400 | 30 | ◯ | ◯ | ◯ | ◯ |
| Example 8 | 15 | 140 | 15 | ◯ | ◯ | ◯ | ◯ |
| Example 9 | 18 | 210 | 20 | ◯ | ◯ | ◯ | ◯ |
| Example | 19 | 210 | 20 | ◯ | ◯ | ◯ | ◯ |
| 10 | | | | | | | |
| Comparative | 40 | 600 | 40 | ◯ | X | Δ | ◯ |
| Example 1 | | | | | | | |
| Comparative | 900 | 150 | 800 | ◯ | ◯ | ◯ | X |
| Example 2 | | | | | | | |
| Comparative | 20 | 210 | 20 | ◯ | X | X | Δ |
| Example 3 | | | | | | | |

The present application claims priority from Japanese Patent Application (Japanese Patent Application No. 2017-154514) filed to the Japan Patent Office on Aug. 9, 2017, the contents of which are hereby incorporated by reference

### INDUSTRIAL APPLICABILITY

The present invention has industrial applicability as a cylindrical molded article having high barrier properties that can be used for various applications.

What is claimed is:

1. A cylindrical molded article comprising:
a cylindrical resin layer I comprising a vinylidene chloride copolymer; and
a cylindrical resin layer II disposed inside the resin layer I and comprising a resin having an SP value of 12.0 (cal/cm³)^{1/2} or more, and
having a total thickness of 100 μm or more.

2. The cylindrical molded article according to claim 1, wherein a content of a vinylidene chloride constituting the vinylidene chloride copolymer is 85% by mass or more, and
a weight average molecular weight of the vinylidene chloride copolymer is 5.0×10⁴ or more.

3. The cylindrical molded article according to claim 1, wherein a sum of thicknesses of the resin layer I and the resin layer II is 30% or more based on a total thickness of the cylindrical molded article of 100%.

4. The cylindrical molded article according to claim 1, wherein an SP value of a resin constituting the resin layer I is 10 to 11.5 (cal/cm³)^{1/2}.

5. The cylindrical molded article according to claim 1, wherein an oxygen transmission rate of the resin layer I is 10000 mL·μm/m²·24 hrs·MPa (23° C. and 65% RH) or less.
